(19) United States
(12) Patent Application Publication
(10) Pub. No.: US 2010/0185421 A1
(43) Pub. Date: Jul. 22, 2010

(54) Method and Apparatus for Pictorial Representation of an Algebraic Expression

(75) Inventor: Paul Kenneth Daly, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/355,998

(22) Filed: Jan. 19, 2009

(51) Int. Cl. G06F 17/10

(52) U.S. Cl. 703/2

(57) ABSTRACT

A method and apparatus for pictorially representing an algebraic expression. The method includes receiving an algebraic expression, displaying a pictorial representation of the algebraic expression, and determining the correct mathematical answer to the algebraic expression.

### BACKGROUND OF THE INVENTION

1. Field of the Invention

Embodiments of the present invention generally relate to a method and apparatus for pictorial representation of pictorial algebra values.

2. Description of the Related Art

When teaching algebra, teachers resort to creative methods to assist students to understand algebraic problems and solutions. The teachers use manipulative, logic games, and diagrams to visually represent various algebraic concepts to the students.

However, it would be useful to utilize an electronic device to assist the teacher in utilizing and creating such manipulative, logic games, and diagrams. Calculators are able to display and solve algebraic equations. However, calculators are not equipped with the ability to pictorially display an algebraic problem.

Therefore, there is a need for a method and/or apparatus for pictorially representing algebraic values on a handheld device.

### SUMMARY OF THE INVENTION

Embodiments of the present invention relate to a method and apparatus for pictorially representing an algebraic expression. The method includes receiving an algebraic expression, displaying a pictorial representation of the algebraic expression, and determining the correct mathematical answer to the algebraic expression.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a front view of an apparatus for pictorially representing an algebraic expression;

FIG. 2 is an embodiment of a block diagram of a computer system for an apparatus for pictorially representing an algebraic expression;

FIG. 3A and 3B are embodiments of a pictorial representation of an algebraic expression; and

FIG. 4 is a flow diagram depicting an embodiment of a method for pictorially representing an algebraic expression.

### DETAILED DESCRIPTION

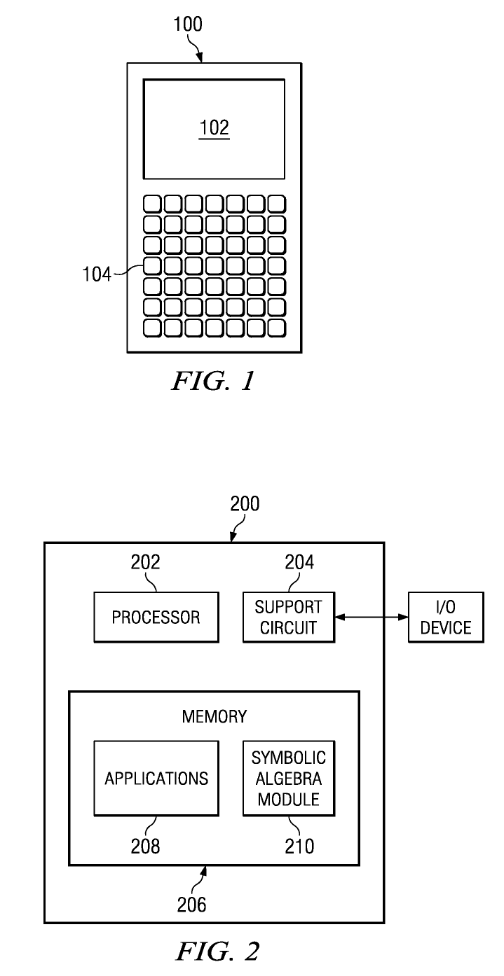

FIG. 1 is an embodiment of a front view of an apparatus 100 for pictorially representing an algebraic expression. The apparatus 100 includes a display screen 102 and an input device 104. The apparatus 100 may be any device that may be utilized for teaching a student, such as, a calculator, a handheld device, a computer, or the like. The apparatus 100 may be also coupled or may include an output device and other modules or devices, such as, audio, video, graphical, printer and/or LED display.

The display screen 102 displays input data and generated results or messages. The display screen 102 may be an LCD screen, a calculator screen, a monitor or any display that may be utilized by the apparatus 100. The input device 104 mat be a keypad, an interactive whiteboard, a touch screen or any device that provides data to the apparatus 100. The input device 104 allows a user to enter data to the apparatus 100. The display screen or the input device may be included within or coupled to the apparatus 100.

FIG. 2 is an embodiment of a block diagram of a computer system 200 for an apparatus for pictorially representing an algebraic expression, such as, apparatus 100 described in FIG. 1. The computer system 200 includes a processor 202, support circuit 204 and memory 206.

The processor 202 may comprise one or more conventionally available microprocessors. The microprocessor may be an application specific integrated circuit (ASIC). The support circuits 204 are well known circuits used to promote functionality of the processor 202. Such circuits include, but are not limited to, cache, power supplies, clock circuits, input/output (I/O) circuits and the like. The memory 204 may comprise random access memory, read only memory, removable disk memory, flash memory, and various combinations of these types of memory. The memory 204 is sometimes referred to as main memory and may, in part, be used as cache memory or buffer memory. The memory 204 may store an operating system (OS), database software, various forms of application software, such as, applications 208 and pictorial algebraic module 210, and the like. It should be noted that a computer readable medium is any medium utilized by a computer system for storing and/or retrieving data.

The applications 208 may include any applications utilized by the apparatus 100 (FIG. 1), the computer system 200, and the like. The applications 208 may include graphic and/or algebraic applications. The pictorial algebraic module 210 translates algebraic expressions to graphic expressions.

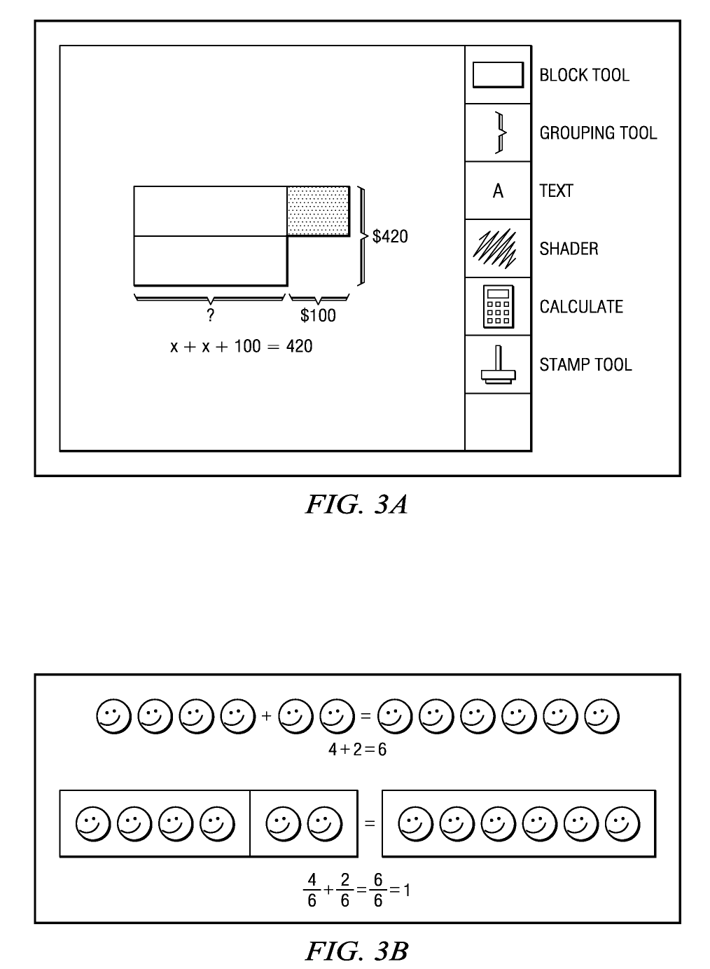

The pictorial algebraic module 210 allows students to manipulate and solve algebraic expressions pictorially. For example, the pictorial algebraic module 210 translates the algebraic expression 2*x=6 as a pictorial representation, such as, drawing shapes. Such shapes can be manipulated and the related pictorial expression can change according to the changes in the expression or the manipulation. The pictorial algebraic module 210 may be used to sketch word problems and solve by assigning values to the graphic shapes. For example, the student may create a strip diagram representing the problem, as shown in FIGS. 3A and 3B.

As such, the pictorial algebraic module groups and/or arranges objects in order to attach mathematical operators, such as, add, subtract, multiply, divide, to properly represent the algebraic expression. Thus, the pictorial representation attaches a value to the created object. The pictorial algebraic module may utilize the graphical system to tie into the existing symbolic math engine, which may replace a symbol (x,y,a,b) with a graphical object. FIGS. 3A and 3B show examples of pictorial and equivalent symbolic representations.

FIG. 3A is an embodiment of a pictorial representation 300 of an algebraic expression. A problem statement may indicate that Ragu and Sam, together, have $410 and that Ragu alone has $100. The question is: how much money does Sam have alone?

As shown in FIG. 3A, the pictorial algebraic module 210 (FIG. 2) translates the input of names and numbers to represent the algebraic problem. Thus, the combination of Ragu and Sam's $410 is pictorially represented and Ragu's $100 is pictorially shown. As a result, a teacher and a student may utilize apparatus 100 to input the problem, view the pictorial representation, input an answer and/or determine if the entered answer is a true or false answer. As such, a student can visually see the pictorial representation of the correct answer, which is $310. As shown in FIG. 3A, a toolbar may be utilized to allow actions to be placed in the screen, or in a separate menu.

FIG. 3B depicts mathematical expressions of addition and division. As shown in FIG. 3B, changing the values in the pictorial expression will result in a change in the graphical representation, and vice versa.

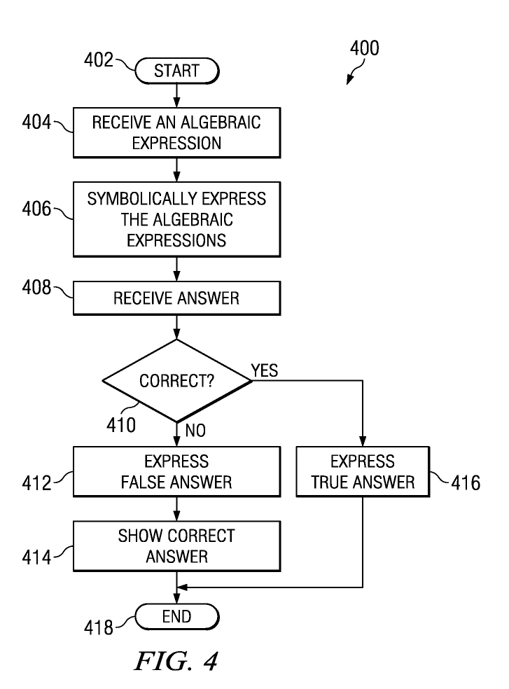

FIG. 4 is a flow diagram depicting an embodiment of a method 400 for pectorially representing an algebraic expression. The method 400 starts at step 402 and proceeds to step 404. At step 404, the method 400 receives an algebraic expression. At step 406, the method 400 pictorially expresses the algebraic expression of the display screen 102 (FIG. 1). At step 408, the method 400 receives an answer to the algebraic expression. At step 410, the method 400 determines if the answer is correct. If the answer is incorrect, the method 400 proceeds to step 412, wherein the method 400 indicates to the user that the answer is false. From step 412, the method 400 proceeds to step 414, wherein the method 400 displays the correct answer to the user. The method 400 may allow the user multiple tries to reach the correct answer. If the answer is correct, the method 400 proceeds from step 410 to step 416. In step 416, the method 400 displays to the user that the answer is true. The method 400 ends at step 418. The method 400 may be utilized to immediately produce the answer, thus, eliminating the need to receive an answer from a user and determining if such answer is false or true.

While the foregoing is directed to embodiments of the present invention, other and further embodiments of the invention may be devised without departing from the basic scope thereof, and the scope thereof is determined by the claims that follow.

What is claimed is:

1. A method for pictorially representing an algebraic expression, wherein the method is coupled to a computer system, the method comprising:
receiving an algebraic expression;
displaying a pictorial representation of the algebraic expression; and
determining the correct mathematical answer to the algebraic expression.

2. The method of claim 1, wherein the pictorial representation is a diagram.

3. The method of claim 1 further comprising:
receiving a mathematical answer to the algebraic expression; and
indicating to a user of the computer system if the answer is at least one of correct or incorrect.

4. Apparatus for pictorially representing an algebraic expression, comprising:
means for receiving an algebraic expression;
means for displaying a pictorial representation of the algebraic expression; and
means for determining the correct mathematical answer to the algebraic expression.

5. The apparatus of claim 4, wherein the pictorial representation is a diagram.

6. The apparatus of claim 4 further comprising:
means for receiving a mathematical answer to the algebraic expression; and
means for indicating to a user of the apparatus if the answer is at least one of correct or incorrect.

7. A computer readable medium comprising software that, when executed by a processor, causes the processor to perform a method for pictorially representing an algebraic expression, the method comprising:
receiving an algebraic expression;
displaying a pictorial representation of the algebraic expression; and
determining the correct mathematical answer to the algebraic expression.

8. The computer readable medium of claim 7, wherein the pictorial representation is a diagram.

9. The computer readable medium of claim 7 further comprising:
receiving a mathematical answer to the algebraic expression; and
indicating to a user if the answer is at least one of correct or incorrect.
